(19) United States
(12) Patent Application Publication
(10) Pub. No.: US 2003/0040943 A1
(43) Pub. Date: Feb. 27, 2003

(54) System and method for selecting arena seat locations for display

(75) Inventors: Cary L. Bates, Rochester, MN (US); Gilford F. Martino, Endwell, NY (US); John M. Santosuosso, Rochester, MN (US); Vincent T. Timon III, Binghamton, NY (US)

Correspondence Address: IBM Corporation, Intellectual Property Law Dept 917 Bldg 006-1, 3605 Highway 52 North, Rochester, MN, 55901-7829, US

(73) Assignee: International Business Machines Corporation, Armonk, NY (US)

(21) Appl. No.: 09/934,913

(22) Filed: Aug. 22, 2001

(51) Int. Cl. G06F 17/60

(52) U.S. Cl. 705/5

(57) ABSTRACT

Arena locations are selected by chances sold to customers for recording and distributing video images of the location. A vend terminal/processor system is used to sell these chances and load them to a chance table. The chance table is accessed by a camera control processor and a response control processor to cause a video camera to record and transmit images of selected arena locations selectively to a TV live or delayed broadcast, a view screen at the arena, or to a remote customer for viewing at a display.

### BACKGROUND OF THE INVENTION

1. Technical Field of the Invention

This invention pertains to a business method and system for selecting seat locations. More particularly, it pertains to the selection of seat locations for video display such as during breaks in action.

2. Background Art

Typically, sports and cultural events in an arena, or some other similar venue such as a stadium, concert hall or theater are recorded for live or delayed video broadcast or other distribution. Camera operators and others, such as editors and producers, scan the audience or other participants in the event for interesting people to record. Then, such as during intermissions or other breaks in the action, or even during the performance or contest itself, video shots of the audience, crowd, team, chorus, or other participants are taken by one or more cameras and selected by an editor or producer for inclusion in the broadcast or distribution.

People often go to great lengths to raise the chance that they, their children or other associates in the audience or crowd, will be included in the video transmission, so that they may be observed by the audience viewing the contest, performance, or other event.

Heretofore, there has been no mechanism provided for an individual viewing the event live or delayed to influence or otherwise raise the chance that a particular individual in the audience or performing group (such as a member of a large choir, a team member, production or support staff) would be selected by the editors and producers for display to the viewing audience.

Producers of such events, and participating teams, leagues, performing groups, etc., and the distributors of the resulting video display, have heretofore not had a way to profit or otherwise benefit from the selection of a particular individual or seat location for display. While advertisers are willing to pay to such producers large fees for a few seconds of time to advertize their products and services or support their cause, heretofore there has not been provided a way for such producers to reap a similar benefit from time, such as during breaks, when displaying shots of the audience or crowd.

There is, therefore, a need in the art to provide a way for event producers to realize a benefit or otherwise capitalize upon broadcast time devoted to video shots of the event attendees, either individuals or groups (such as family groups, team supporters, business or cultural associations). Similarly, there is a need in the art for a way for such attendees and viewers of such events to raise the chance or assure that they or other individuals or family or other groups they select will be included in the broadcast or otherwise recorded as attending the event. Providing such an assurance or increased chance that a particular seat or location will be included in the record or broadcast may increase viewing audience attention to the show, and that may be translated into increased advertising revenues as well.

It is an object of the invention to provide an improved system and method for selecting individuals or groups attending an event for inclusion in a video record made of the event.

It is a further object of the invention to provide a system and method whereby individuals or groups attending an event may raise the chance or assure that their attendance at the event will be recorded for live or delayed broadcast or other distribution.

It is a further object of the invention to provide a system and method whereby an individual or group expecting to view an event may raise the chance or assure that an individual or group attending the event will be selected for broadcast or other distribution of a video record of the event.

It is a further object of the invention to provide a system and method for allowing event organizers, event venue owners and broadcast rights holders to charge spectators a fee for an increased chance or assurance that selected participants or locations of the venue will be selected for broadcast or video distribution of the event.

### SUMMARY OF THE INVENTION

System and method for selecting an event location for inclusion in a record made of the event, including selling to a customer a chance with respect to a location at the arena; with reference to that chance, selecting an arena location; and making a video record of said location.

In accordance with an aspect of the invention, there is provided a computer program product configured to be operable to select an arena location and make and transmit video images from said location.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is system diagram illustrating an exemplary embodiment of the invention.

FIG. 2 is a flow chart illustrating the purchase of a chance ticket in accordance with a preferred embodiment of the invention.

FIG. 3 is a data structure diagram illustrating an entry in the chance table of FIG. 2.

FIG. 4 is a flow chart illustrating the operation of an exemplary embodiment of the invention at a break in arena action.

FIG. 5 is a flow chart illustrating the operation of an exemplary embodiment of the invention for selecting a record from the chance table of FIG. 2 for e-mail transmission.

### BEST MODE FOR CARRYING OUT THE INVENTION

In accordance with the preferred embodiment of the invention, chances for having image(s) of selected event venue locations selected for video distribution are sold to ticket purchasers or others. In accordance with further embodiments of the invention, additional services may be offered, such as e-mailing MPEG and/or JPEG soft copies of images to customers, or providing them on media (such as diskette, CD or DVD) at the venue or otherwise.

In accordance with an exemplary embodiment of the invention, a business method and system is provided whereby producers of an event may sell customers chances for people, groups, or venue scenes to be put on camera. Such customers include individuals or groups buying tickets to attend the event and individuals or groups viewing or expecting to view the event, such as on the Internet, TV, web TV. Also, individuals (hereafter, individuals includes single persons, and groups or associations of individuals) may select areas or particular seats that they would like to see, and then pay for an increased chance or an assurance that such area or seat will be included in the broadcast or other distribution of the event.

In accordance with these exemplary embodiments of the invention, a user buys a chance (increased probability or assurance) that a particular seat(s) location will be selected by the producers or others for being put on camera. These chances may be purchased at the time the ticket is purchased for attending the event, or later by the ticket purchaser or even others. The seat locations for which such chances have been purchased are recorded in a chance table, and the camera operators or editors select locations from that chance table for the video shots.

In accordance with a further exemplary embodiment of the invention, in addition to being put on a TV broadcast of the event, soft copies of images made of seat locations may be provided for E-mail or other distribution to customers, or offered for sale. Such images may be provided in the form of MPEG, JPEG, bit map, or other such images. In this way, for example, customers, such as parents or other relatives, could see that others, such as their children, made it to the game. One level of such service would have a single shot made at a particular or random time of the seat location, and e-mailed to the customer. At a higher level of service, an automatic camera could take pictures at every pass, and the resulting images E-mailed to the customer. Further, with the reception of each such image, a web TV set top box may be operated to immediately open the message and display the picture in a window on the screen, thus allowing viewers at home to relate to their friends and/or family members attending the game.

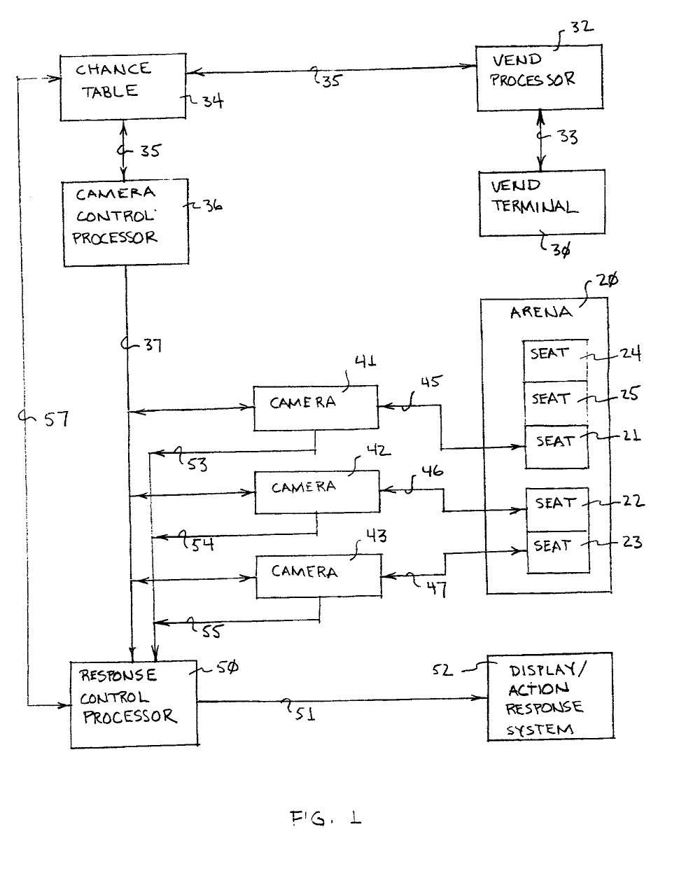

Referring to FIG. 1, an exemplary embodiment of a system for implementing the invention is presented. As is represented by line 33, vend terminal 30 is connected to a vend processor 32 which, as is shown by line 35, is connected to chance table 34. As is represented by line 35, chance table 34 is accessed by camera control processor 36 and response control processor 50. As is represented by line 37, camera control processor is connected to one or more cameras 41-43, or by way of a producer to one or more camera operators, to select particular seat locations 21-25 in arena 20, for camera shots. As is represented by lines 53-55, the video feed back from cameras 41-43 is fed to response control processor 50 which, as is represented by line 57, correlates the TV shot with a particular customer record in chance table 34. As is represented by line 51, response control processor 50 (either automatically or under control of a producer, editor, or other individual) feed the video record to a display or action response system 52 for broadcast display or other response in accordance with the service level for the customer record from chance table 34.

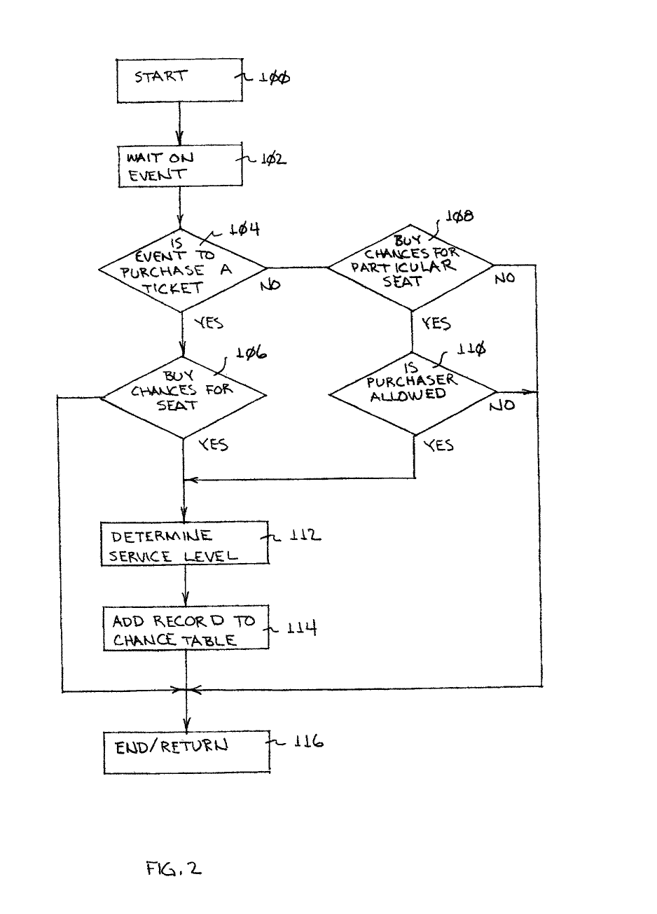

Referring to FIG. 2, in accordance with an exemplary embodiment of the method of the invention, the operation of vend processor 32 and vend terminal 30 is illustrated for creating in chance table 34 a customer record 120. This process may be executed vend processor 32 and terminal 30 in a kiosk or as part of an online ticket purchase system. In steps 100 and 102, the vend processor 32 waits on an event. When, in step 104, a ticket purchase event is recognized, in step 106 it is determined if the customer desires to buy chances for video display of the seat location for which the ticket is purchased, or in step 108 if the event is to buy a chance for a particular seat, such as a previously sold seat. In the case of an event to buy a chance for a particular seat location(s), in step 110 it is determined if the purchaser is allowed to buy the chance. In step 112, processor 32 determines the service level and in step 114 the resulting record 120 is added to chance table 34 for this event.

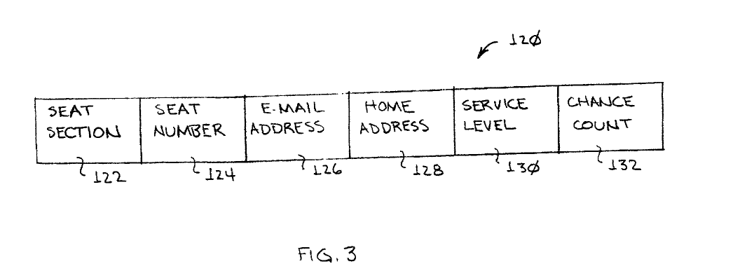

Referring to FIG. 3, in accordance with an exemplary embodiment of the invention, a customer record 120 in chance table 34 includes seat location, including seat section 122 and seat number(s) 124, E-mail address 126, home address 128, service level 130, and chance count 132. Service level 130 may include a value of “chance”, in which event the record is included in the set from which seat locations are selected for TV broadcast. Service level 130 may included the value “e-mail”, in which the record is included in the set from which e-mail records are sent to address 126, or “mail”—and included in the set for which video records are mailed to home address 128. Chance count 132 represents an increase in the selection probability for which the customer pays—which would be 100% for video records to be sent to E-mail address 126 or home address 128, and some value equal to or less that 100% for TV broadcast. This value will be used by camera control processor when scanning chance table 34 and directing cameras 41-43 and response control processor 50 to taking video shots and providing appropriate action in response to the service level/chance count fields 130, 132.

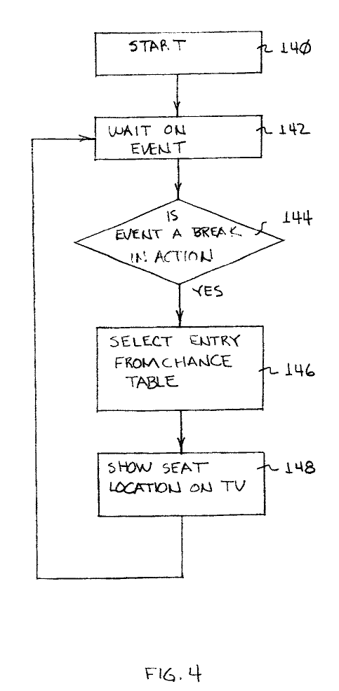

Referring to FIG. 4, a flow chart illustrates an exemplary embodiment of the logic flow that takes place during a break in the action of the event. In steps 142 and 144, when a break in the action is detected, a record 120 is randomly picked by camera control processor 36 from chance table 34 and the seat location 21-25 selected by fields 122, 124 recorded by a camera 41-43 and displayed by system 52. A break includes a commercial break, a break in the action, or even a continues time during the action. In the later case, for example, display system 52 may show the resulting images on the big screens at the games, or continuously in a display window under control of a set-top box.

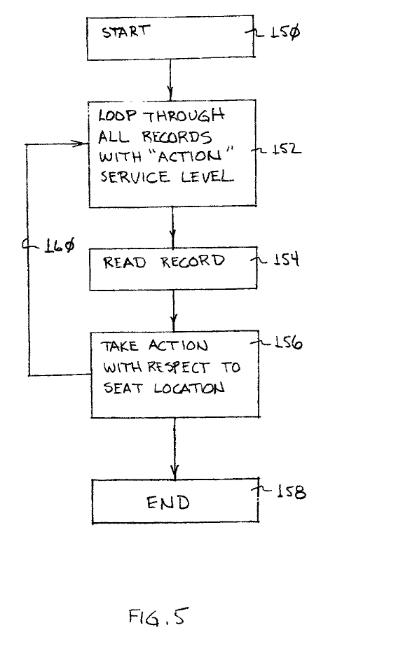

Referring to FIG. 5, a flow chart illustrates an exemplary embodiment of the logic flow executed by response control processor 50 to go through all chance records 120 in chance table 34 to select those to E-mail to customers, or for which some other such action is required. Loop 16 includes in step 152 determining if this record 120 has an “action” service level 130, in step 154 reading the record and in step 156 causing camera control processor 36 and action response system 52 to provide the video record and take the action required by service level 130. Such actions include, for example, E-mailing a video record to the customer, mailing a video file on diskette to the customer address, and so forth.

### ADVANTAGES OVER THE PRIOR ART

It is an advantage of the invention that there is provided an improved system and method for selecting individuals or groups attending an event for inclusion in a video record made of the event.

It is an advantage of the invention that there is provided a system and method whereby individuals or groups attending an event may raise the chance or assure that their attendance at the event will be recorded for live or delayed broadcast or other distribution.

It is an advantage of the invention that there is provided a system and method whereby an individual or group expecting to view an event may raise the chance or assure that an individual or group attending the event will be selected for broadcast or other distribution of a video record of the event.

It is an advantage of the invention that there is provided a system and method for allowing event organizers, event venue owners and broadcast rights holders to charge spectators a fee for an increased chance or assurance that selected participants or locations of the venue will be selected for broadcast or video distribution of the event.

### ALTERNATIVE EMBODIMENTS

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for selecting an arena location for inclusion in a record made of an event, comprising the steps of:
selling to a customer a chance with respect to a location in said arena;
with reference to said chance, selecting an arena location; and
making a video record of said location.

2. The method of claim 1, said customer being a purchaser of a ticket to attend said event.

3. The method of claim 1, said customer being a prospective viewer of a video record of said event.

4. The method of claim 1, further comprising the step of:
broadcasting said video record.

5. The method of claim 1, further comprising the step of transmitting said video record to a customer e-mail address.

6. The method of claim 1, further comprising the step of sending a copy of said video record to a physical address of said customer.

7. The method of claim 1, further comprising the step of broadcasting said video record live during a break in the action of said event.

8. The method of claim 7, further comprising the step of displaying said video record on a screen for viewing by persons attending said event.

9. The method of claim 1, said location being a specific seat location in said arena.

10. The method of claim 1, said location being a section of seats in said arena.

11. The method of claim 1, further comprising the steps of:
selling to said customer a chance for an action, said action selectively including TV broadcast and transmission of a video record to an E-mail address, mail transmission, and transmission to a set top box for display in a window at a monitor.

12. The method of claim 1, further comprising the step of storing a record of said chance in a chance table.

13. The method of claim 12, said selecting step including the step of randomly selecting from said chance table arena locations for video recording.

14. The method of claim 12, said randomly selecting step including the step assigning to each record selection probability as a function of the value of said chance.

15. The method of claim 14, further comprising the step of offering to sell to said customer a chance probability value equal to 1.0.

16. The method of claim 15, further comprising the step of offering to sell to said customer a chance probability value of less than 1.0.

17. The method of claim 16, further comprising the step of offering to sell to said customer chance probability values for a plurality of chance probability values at different prices.

18. The method of claim 12, said record including seat location and service level.

19. The method of claim 18, said service level selectively specifying that a single shot made at a particular or random time of the seat location be transmitted to said customer, or that an automatic camera take a picture of said seat location at each of a plurality of passes with the resulting images transmitted to said customer.

20. The method of claim 19, said resulting image being transmitted to a set top box for display to said customer in a window of a video display screen.

21. System for selecting an arena location for inclusion in a record made of an event, comprising:
a vend station;
a camera control processor;
a camera; and
a response control processor;
said vend station for selling chances to customers and making a record of said chances;
said camera control processor responsive to said record of said chances for selecting said arena locations and directing said camera to make a video record a said location;
said response control processor responsive to said record of said chances and said camera for selectively displaying or transmitting said video record.

22. The system of claim 21, further comprising a chance table for recording said record of said chances, each record in said table including an arena location field and a service level field.

23. The system of claim 22, said response control processor further for scanning said chance table for specific entries in said service level field and for each such entry initiating a corresponding action response.

24. The system of claim 23, said action response selectively being that a single shot made at a particular or random time of the seat location be transmitted to said customer, or that an automatic camera take a picture of said seat location at each of a plurality of passes with the resulting images transmitted to said customer.

25. The method of claim 23, said action response being that said video record be transmitted to a set top box for display to said customer in a window of a video display screen.

26. A program storage device readable by a machine, tangibly embodying a program of instructions executable by a machine to perform method steps for selecting an arena location for inclusion in a record made of an event, said method steps comprising:
selling to a customer a chance with respect to a location in said arena;
with reference to said chance, selecting an arena location; and
making a video record of said location.

27. The program storage device of claim 26, said customer being a purchaser of a ticket to attend said event.

28. The program storage device of claim 26, said customer being a prospective viewer of a video record of said event.

29. The program storage device of claim 26, said method steps further comprising the step of:
broadcasting said video record.

30. The program storage device of claim 26, said method steps further comprising the step of transmitting said video record to a customer e-mail address.

31. The program storage device of claim 26, said method steps further comprising the step of sending a copy of said video record to a physical address of said customer.

32. The program storage device of claim 26, said method steps further comprising the step of broadcasting said video record live during a break in the action of said event.

33. The program storage device of claim 32, said method steps further comprising the step of displaying said video record on a screen for viewing by persons attending said event.

34. The program storage device of claim 26, said location being a specific seat location in said arena.

35. The program storage device of claim 26, said location being a section of seats in said arena.

36. The program storage device of claim 26, said method steps further comprising the steps of:
selling to said customer a chance for an action, said action selectively including TV broadcast and transmission of a video record to an E-mail address, mail transmission, and transmission to a set top box for display in a window at a monitor.

37. The program storage device of claim 26, said method steps further comprising the step of storing a record of said chance in a chance table.

38. The program storage device of claim 37, said selecting step including the step of randomly selecting from said chance table arena locations for video recording.

39. The program storage device of claim 37, said randomly selecting step including the step assigning to each record selection probability as a function of the value of said chance.

40. The program storage device of claim 39, said method steps further comprising the step of offering to sell to said customer a chance probability value equal to 1.0.

41. The program storage device of claim 40, said method steps further comprising the step of offering to sell to said customer a chance probability value of less than 1.0.

42. The program storage device of claim 41, said method steps further comprising the step of offering to sell to said customer chance probability values for a plurality of chance probability values at different prices.

43. The program storage device of claim 37, said record including seat location and service level.

44. The program storage device of claim 43, said service level selectively specifying that a single shot made at a particular or random time of the seat location be transmitted to said customer, or that an automatic camera take a picture of said seat location at each of a plurality of passes with the resulting images transmitted to said customer.

45. The program storage device of claim 44, said resulting image being transmitted to a set top box for display to said customer in a window of a video display screen.

46. A computer program product or computer program element for operating a computer according to the steps of:
selling to a customer a chance with respect to a location in said arena;
with reference to said chance, selecting an arena location; and
making a video record of said location.

47. The computer program product or computer program element of claim 46, said steps further comprising:
with reference to said chance, selectively communicating said video record to a television broadcast, screen display at said arena, or as a video file to a customer location for viewing.
